(19) United States
(12) Patent Application Publication
(10) Pub. No.: US 2026/0179637 A1
(43) Pub. Date: Jun. 25, 2026

(54) ELECTRONIC DEVICE AND CONTROLLING METHOD THEREOF

(71) Applicant: SAMSUNG ELECTRONICS CO., LTD., Suwon-si (KR)

(72) Inventors: Jeongook SONG, Suwon-si (KR); Changwoo HAN, Suwon-si (KR); Kangseok CHOI, Suwon-si (KR); Jinyoung LEE, Suwon-si (KR); Jonguk YOO, Suwon-si (KR); Joonyoung YANG, Suwon-si (KR)

(73) Assignee: SAMSUNG ELECTRONICS CO., LTD., Suwon-si (KR)

(21) Appl. No.: 19/539,793

(22) Filed: Feb. 13, 2026

Related U.S. Application Data
(63) Continuation of application No. PCT/KR2025/020877, filed on Dec. 5, 2025.

(30) Foreign Application Priority Data
Dec. 13, 2024 (KR) 10-2024-0186343

(51) Int. Cl. G10L 21/0216; G10L 15/02; G10L 15/08; G10L 15/16; G10L 25/78

(52) U.S. Cl. CPC G10L 21/0216; G10L 15/02; G10L 15/16; G10L 25/78; G10L 2015/088; G10L 2025/783

(57) ABSTRACT

An electronic device electronic device includes memory and a processor that executes one or more instructions to obtain a first voice signal corresponding to a user voice from an audio signal based on speech feature information including a user speech feature, obtain a noise signal from the audio signal based on the audio signal and the first voice signal, the noise signal being distinguished from the first voice signal, identify one or more clean sections in the first voice signal, based on the first voice signal and the noise signal, the one or more clean sections having an amount of the noise signal that is less than a threshold value, update the speech feature information based on voice data corresponding to the one or more clean sections, and obtain a second voice signal corresponding to the user voice from the audio signal based on the updated speech feature information.

### CROSS-REFERENCE TO RELATED APPLICATIONS

This application is a continuation of National Stage entry of International Application No. PCT/KR2025/020877 filed on Dec. 5, 2025, which is based on and claims priority from Korean Patent Application No. 10-2024-0186343, filed on Dec. 13, 2024, in the Korean Intellectual Property Office, the disclosures of each of which being incorporated by reference herein in their entireties.

### BACKGROUND

### 1. Field

The present disclosure relates to an electronic device and a controlling method thereof, and more particularly, to an electronic device that may enhance a sound quality of a user voice, and a controlling method thereof.

### 2. Description of Related Art

Recently, the development of technology related to speech recognition has been accelerating with the advancement of artificial intelligence technology. In particular, in speech recognition technology, the importance of technology for enhancing a sound quality of a user voice by removing noise from the user voice that includes noise, that is, sound quality enhancement (speech enhancement) technology, is being strongly emphasized.

However, achieving perfect sound quality enhancement remains a very challenging issue. In particular, it is difficult to accurately isolate the user voice in a complex noise environment, such as noise in a space where the user speaks, a voice generated from another user speech, and noise occurring while a signal corresponding to the user voice is received through a microphone. In addition, if excessive filtering is applied during a sound quality enhancement process, details of the user voice may be lost, and an audio quality may deteriorate.

A personalized sound quality enhancement technology (known as personalized speech enhancement (PSE)) has been proposed, which aims to enhance a sound quality by optimizing the same for a specific user. However, this PSE technology uses a feature vector extracted from a pre-registered user voice for the sound quality enhancement, which may cause inconvenience in that the user is required to pre-register the user voice. In addition, this PSE technology performs the sound quality enhancement based on the pre-registered voice (i.e., by using the fixed feature vector), and thus may provide a limited sound quality enhancement effect.

A technology known as on-the-fly personalized speech enhancement has been proposed, which extracts a feature vector from a voice in which the user speaks a predetermined keyword, without requiring any prior voice registration procedure and uses the same for the sound quality enhancement. However, this on-the-fly personalized speech enhancement technology still performs the sound quality enhancement based on the user voice including the predetermined keyword, making it difficult to expect continuous and gradual sound quality enhancement.

### SUMMARY

Provided are an electronic device that may effectively and efficiently enhance a sound quality of a user voice and the accuracy of voice recognition in a noisy environment, and a controlling method thereof.

Additional aspects will be set forth in part in the description which follows and, in part, will be apparent from the description, or may be learned by practice of the presented embodiments.

According to an embodiment of the present disclosure, an electronic device may include: a memory storing at least one instruction; and a processor configured to execute the at least one instruction, wherein the processor is configured to obtain a first voice signal corresponding to a user voice from an audio signal based on speech feature information including information about a user speech feature if the audio signal is obtained, obtain a noise signal that is distinguished from the first voice signal from the audio signal based on the audio signal and the first voice signal, identify at least one clean section in the first voice signal, in which an amount of the noise signal is less than a threshold value, based on the first voice signal and the noise signal, update the speech feature information based on voice data corresponding to the at least one clean section, and obtain a second voice signal corresponding to the user voice from the audio signal based on the updated speech feature information.

The speech feature information may include information about the user speech feature for a predetermined keyword, and the processor may be configured to obtain the first voice signal from the audio signal based on text feature information including information about a feature of the keyword and the speech feature information.

The processor may be configured to obtain a text corresponding to the voice data by inputting the voice data into a voice recognition module, obtain text data corresponding to the at least one clean section based on the text, update the text feature information based on the text data, and update the speech feature information based on the updated text feature information and the voice data.

The processor may be configured to obtain information about the keyword and a reference voice signal including a user voice corresponding to the keyword before the audio signal is obtained, obtain the text feature information based on the information about the keyword, obtain the speech feature information by extracting a feature corresponding to the text feature information from the reference voice signal, and store the text feature information and the speech feature information in the memory.

The processor may be configured to obtain the text feature information by inputting the information about the keyword into a text feature extraction module including a trained neural network, and obtain the speech feature information by inputting the reference voice signal and the text feature information into a speech feature extraction module including a trained neural network.

The processor may be configured to obtain mask information for removing a signal not corresponding to the user voice based on the audio signal and the speech feature information, and obtain the first voice signal by applying the mask information to the audio signal.

The processor may be configured to obtain the mask information by inputting the audio signal and the speech feature information into a sound quality enhancement module including a trained neural network.

The sound quality enhancement module may be trained to output the first voice signal and the noise signal included in the input audio signal, and the processor may be configured to obtain the first voice signal and the noise signal by inputting the audio signal and the speech feature information into the sound quality enhancement module.

The processor may be configured to train the neural network included in at least one of the text feature extraction module, the speech feature extraction module, or the sound quality enhancement module based on the updated speech feature information and the updated text feature information.

The processor may be configured to obtain the noise signal by removing a component corresponding to the first voice signal from the audio signal.

The processor may be configured to obtain the noise signal by estimating a signal in a first section of the audio signal that does not include the first voice signal as the noise signal in a second section that includes the first voice signal and is adjacent to the first section.

The at least one clean section may include a first clean section and a second clean section after the first clean section, and the processor may be configured to update the speech feature information based on the voice data corresponding to the first clean section and text data corresponding to the first clean section, and update the updated speech feature information again based on the voice data corresponding to the second clean section and text data corresponding to the second clean section.

The audio signal may not include a signal corresponding to a keyword.

According to an embodiment of the present disclosure, a method of an electronic device may include: obtaining a first voice signal corresponding to a user voice from an audio signal based on speech feature information including information about a user speech feature if the audio signal is obtained; obtaining a noise signal that is distinguished from the first voice signal from the audio signal based on the audio signal and the first voice signal; identifying at least one clean section in the first voice signal, in which an amount of the noise signal is less than a threshold value, based on the first voice signal and the noise signal; updating the speech feature information based on voice data corresponding to the at least one clean section; and obtaining a second voice signal corresponding to the user voice from the audio signal based on the updated speech feature information.

The speech feature information may include information about the user speech feature for a predetermined keyword, and the obtaining of the first voice signal may include obtaining the first voice signal from the audio signal based on text feature information including information about a feature of the keyword and the speech feature information.

The updating of the speech feature information may include obtaining a text corresponding to the voice data by inputting the voice data into a voice recognition module, obtaining text data corresponding to the at least one clean section based on the text, updating the text feature information based on the text data, and updating the speech feature information based on the updated text feature information and the voice data.

The method may further include: obtaining information about the keyword and a reference voice signal including a user voice corresponding to the keyword before the audio signal is obtained, obtaining the text feature information based on the information about the keyword, obtaining the speech feature information by extracting a feature corresponding to the text feature information from the reference voice signal, and storing the text feature information and the speech feature information in the memory.

The obtaining of the text feature information may include obtaining the text feature information by inputting the information about the keyword into a text feature extraction module including a trained neural network, and the obtaining of the speech feature information may include obtaining the speech feature information by inputting the reference voice signal and the text feature information into a speech feature extraction module including a trained neural network.

The obtaining of the first voice signal may include obtaining mask information for removing a signal not corresponding to the user voice based on the audio signal and the speech feature information, and obtaining the first voice signal by applying the mask information to the audio signal.

The obtaining of the mask information may include obtaining the mask information by inputting the audio signal and the speech feature information into a sound quality enhancement module including a trained neural network.

According to an embodiment of the present disclosure, an electronic device may include memory storing at least one instruction; and a processor configured to execute the at least one instruction, wherein the processor is configured to obtain a first voice signal corresponding to a user voice from an audio signal based on speech feature information including information about a user speech feature, obtain a noise signal from the audio signal based on the audio signal and the first voice signal, the noise signal being distinguished from the first voice signal, identify at least one clean section in the first voice signal, based on the first voice signal and the noise signal, the at least one clean section having an amount of the noise signal that is less than a threshold value, update the speech feature information based on voice data corresponding to the at least one clean section, and obtain a second voice signal corresponding to the user voice from the audio signal based on the updated speech feature information.

According to an embodiment of the present disclosure, an electronic device may include: memory that stores program code, and at least one processor that executes the program code to cause the at least one processor to obtain a first voice signal corresponding to a user voice from an audio signal based on user speech feature vectors, identify at least one clean section in the first voice signal, the at least one clean section having an amount of noise that is less than a threshold value, update the user speech feature vectors based on voice data corresponding to the at least one clean section, and obtain a second voice signal corresponding to the user voice from the audio signal based on the updated user speech feature vectors.

### BRIEF DESCRIPTION OF THE DRAWINGS

The above and other aspects, features, and advantages of certain embodiments of the present disclosure will become more apparent from the detailed description taken in conjunction with the accompanying drawings, in which:

FIG. 1 is a block diagram showing a brief configuration of an electronic device according to an embodiment of the present disclosure,

FIG. 2 is a block diagram showing a plurality of modules according to an embodiment of the present disclosure,

FIG. 3 is a block diagram showing a plurality of modules according to an embodiment of the present disclosure,

FIG. 4 is a block diagram showing a specific configuration of an electronic device according to an embodiment of the present disclosure, and

FIG. 5 is a flowchart showing a controlling method of an electronic device according to an embodiment of the present disclosure.

### DETAILED DESCRIPTION

The disclosure may be variously modified and have several embodiments, and specific embodiments of the disclosure are thus illustrated in the accompanying drawings and described in detail in this specification. However, it should be understood that the scope of the present disclosure are not limited to specific embodiments, and include all modifications, equivalents, and alternatives according to an embodiment of the present disclosure. Throughout the accompanying drawings, similar components are denoted by similar reference numerals.

In describing the present disclosure, omitted is a detailed description of a case where it is decided that a detailed description of the known functions or configurations related to the present disclosure may unnecessarily obscure the gist of the present disclosure.

In addition, the following embodiment may be modified in several different forms, and the scope and spirit of the present disclosure are not limited to the following embodiments. Rather, these embodiments make the disclosure thorough and complete, and are provided to completely convey the spirit of the disclosure to those skilled in the art.

Terms used in the disclosure are used only to describe the specific embodiments rather than limit the scope of the disclosure. A term of a singular number may include its plural number unless explicitly indicated otherwise in the context.

In the present disclosure, the expression such as “have”, “may have”, “include”, or “may include”, indicates the presence of a corresponding feature (for example, a numerical value, a function, an operation, or a component such as a part), and does not exclude the presence of an additional feature.

In the present disclosure, the expression such as “A or B”, “least one of A and/or B”, or “one or more of A and/or B” may include all possible combinations of items enumerated together. For example, “A or B”, “at least one of A and B”, or “at least one of A or B” may indicate all of 1) a case in which at least one A is included, 2) a case in which at least one B is included, or 3) a case in which both of at least one A and at least one B are included.

The expressions such as “first” and “second”, used in the present disclosure, may indicate various components regardless of the sequence and/or importance of the components. These expressions are only used to distinguish one component and another component from each other, and do not limit the corresponding components.

If any component (for example, a first component) is mentioned to be “(operatively or communicatively) coupled with/to” or “connected to” another component (for example, a second component), it should be understood that the any component is directly coupled to another component or may be coupled to another component through yet another component (for example, a third component).

On the other hand, if any component (for example, the first component) is mentioned to be “directly coupled with/to” or “directly connected to” another component (for example, the second component), it should be understood that yet another component (for example, the third component) is not present between any component and another component.

An expression such as “configured (or set) to”, used in the present disclosure, may be replaced by an expression such as “suitable for”, “having the capacity to”, “designed to”, “adapted to”, “made to”, or “capable of”, depending on a context. The expression “configured (or set) to” does not necessarily indicate “specifically designed to” in terms of hardware.

Instead, the expression “a device configured to”, in any context, may indicate that the device may “perform˜” together with another device or component. For example, a “processor configured (or set) to perform A, B, and C” may indicate a dedicated processor (for example, an embedded processor) that may perform the corresponding operations or a generic-purpose processor (for example, a central processing unit (CPU) or an application processor) that may perform the corresponding operations by executing one or more software programs stored in a memory device.

In the embodiments, a “module” or a “part” may perform at least one function or operation, and be implemented by hardware or software or be implemented by a combination of hardware and software. In addition, a plurality of “modules” or a plurality of “parts” may be integrated in at least one module and be implemented by the processor except for a “module” or a “part” that needs to be implemented by specific hardware.

Meanwhile, the various elements and areas in the drawings are schematically shown. Therefore, the spirit of the disclosure is not limited by relative sizes or intervals shown in the accompanying drawings.

Hereinafter, an embodiment of the disclosure is described in detail with reference to the accompanying drawings so that those skilled in the art to which the disclosure pertains may easily practice the disclosure.

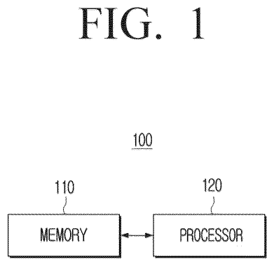

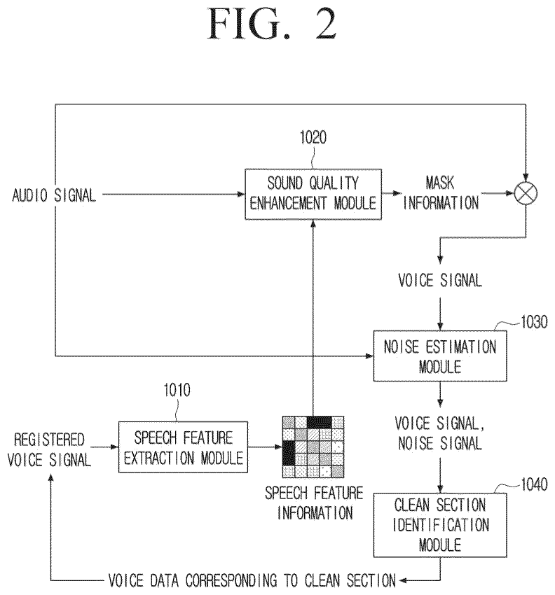

FIG. 1 is a block diagram showing a brief configuration of an electronic device 100 according to an embodiment of the present disclosure. In addition, FIG. 2 is a block diagram showing a plurality of modules according to an embodiment of the present disclosure.

As shown in FIG. 1, the electronic device 100 may include a memory 110 and a processor 120.

The electronic device 100 refers to a device that may enhance (or improve) a sound quality of a user voice. In addition, the electronic device 100 may perform voice recognition on the user voice having the enhanced sound quality, and control the electronic device 100 by using a voice recognition result. For example, the electronic device 100 may be a device such as a smartphone, a tablet personal computer (PC), or a television (TV), and/or may also be a device such as a robot or a server. There is no particular limitation on a type of the electronic device 100 according to the present disclosure.

The memory 110 may store at least one instruction regarding the electronic device 100. In an embodiment, the memory 110 may store program code for various functions of the electronic device 100 described in more detail below. In addition, the memory 110 may store an O/S (Operating System) for operating the electronic device 100. In addition, the memory 110 may store various software programs or applications for operating the electronic device 100 according to various embodiments of the present disclosure. In addition, the memory 110 may include a semiconductor memory such as a flash memory or a magnetic storage medium such as a hard disk.

In detail, the memory 110 may store various software modules for operating the electronic device 100 according to the various embodiments of the present disclosure, and the processor 120 may execute the various software modules stored in the memory 110 to control the operation of the electronic device 100. In an embodiment, the memory 110 may be accessed by the processor 120 to execute the program code stored in the memory 110 to cause the processor 120 to perform various functions of the electronic device 100 described in detail below. That is, the memory 110 may be accessed by the processor 120, and reading, writing, modifying, deleting, updating, or the like of data by the processor 120 may be performed on the memory 110.

Meanwhile, in the present disclosure, the term “the memory 110” may be used to indicate a concept including the memory 110, a read only memory (ROM), a random access memory (RAM) disposed in the processor 120, or a memory card (e.g., a micro secure digital (SD) card or the memory stick) mounted in the electronic device 100.

In an embodiment, the memory 110 may store information about a plurality of modules, in particular, information about a neural network model among the plurality of modules, audio signals, voice signals, the noise signals, voice data, text data, speech feature information, text feature information, or the like. In addition, the memory 110 may store various information necessary within a range for achieving a purpose of the present disclosure, and the information stored in the memory 110 may be updated as information is received from an external device or input by a user.

The processor 120 may control overall operations of the electronic device 100. In detail, the processor 120 may be connected to components of the electronic device 100 including the memory 110, and may control the overall operations of the electronic device 100 by executing at least one instruction stored in the memory 110 as described above.

The processor 120 may be implemented in various ways. For example, the processor 120 may be implemented as at least one of an application specific integrated circuit (ASIC), an embedded processor, a microprocessor, a hardware control logic, a hardware finite state machine (FSM), and/or a digital signal processor (DSP). Meanwhile, in the present disclosure, the term “processor” may be used as a concept including a central processing unit (CPU), a graphic processing unit (GPU), a main processing unit (MPU), or the like.

In an embodiment, the processor 120 may obtain a voice signal having the enhanced sound quality from an audio signal by using the plurality of modules. As shown in FIG. 2, the plurality of modules may include a speech feature extraction module 1010, a sound quality enhancement module 1020, a noise estimation module 1030, and a clean section identification module 1040.

Hereinafter, for convenience of description, it is assumed that the plurality of modules are all implemented by the processor 120 of the electronic device 100. However, the various embodiments according to the present disclosure may also be applied even if at least one module among the plurality of modules is implemented by an external device. Hereinafter, the various embodiments implemented by the processor 120 by using the plurality of modules are described with reference to FIGS. 1 and 2.

The processor 120 may obtain the audio signal. In detail, the processor 120 may receive the audio signal through a microphone included in the electronic device 100, or may receive the audio signal from the external device through a communication interface 130 included in the electronic device 100.

The “audio signal” may include a signal corresponding to a user voice and a noise signal. Hereinafter, the signal corresponding to the user voice may be briefly referred to as the “voice signal.” There is no particular limitation on a length of the audio signal, and the processor 120 may process the audio signals obtained continuously in real time.

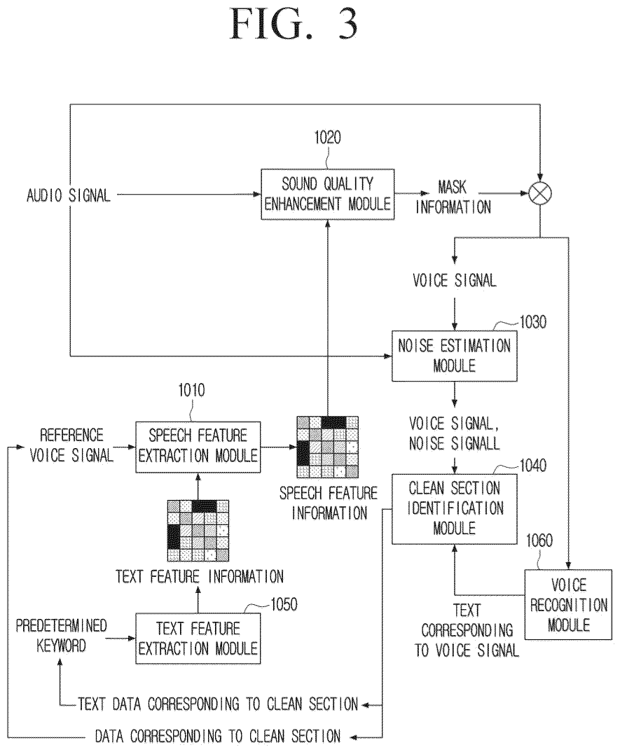

The audio signal may not include a signal corresponding to a keyword. The keyword may be predetermined. That is, the audio signal according to the present disclosure is not limited to a signal received in a case where the user speaks a specific keyword. For example, the audio signal may include the user voice, such as “Set an alarm for 3 pm today.” The audio signal may also include the signal corresponding to the keyword, which is described below with reference to FIG. 3.

The “noise signal” may collectively refer to a signal that is distinguished from the user voice. For example, the noise signal may be a signal other than the user voice. For example, the noise signal may include information about noise in a space where the user speaks, a voice generated from another user speech, and noise occurring in a process of receiving the signal corresponding to the user voice through the microphone, or the like.

The processor 120 may obtain a first voice signal corresponding to the user voice from an audio signal based on the speech feature information including information about a user speech feature if the audio signal is obtained.

The “speech feature information” may collectively refer to information representing the user speech feature. For example, the user speech feature may include one or more user speech feature vectors. The speech feature information may include a vector representing a unique feature of the user that is extracted from a voice spoken by the user. The speech feature information may be replaced with a term such as a “speech feature value”, a “speech feature vector”, or “speech feature embedding.” The speech feature information may be obtained after the audio signal is obtained, or may also be pre-obtained before the audio signal is obtained and stored in the memory 110.

Referring to FIG. 2, the processor 120 may obtain the speech feature information by using the speech feature extraction module 1010. The “speech feature extraction module 1010” may be a neural network model (i.e., speech feature extraction model) trained to extract the user speech feature from a registered voice signal that is input. In an embodiment, the speech feature extraction module 1010 may include a second neural network model and may include other components.

The “registered voice signal” refers to a signal corresponding to a user voice registered before the audio signal to be processed is input, and may be referred to as a voice sample that includes a unique voice feature of the user. The registered voice signal may be registered through a process in which the user speaks a keyword at least a single time and the user voice is registered by determining whether the spoken word matches the keyword.

For example, the processor 120 may perform a short-time Fourier transform (STFT) to decompose a reference voice signal into a plurality of frequency bands and generate a spectrogram that includes time and frequency information. In addition, the processor 120 may input the spectrogram into the speech feature extraction model to obtain the speech feature information expressed as the vector.

The processor 120 may obtain mask information for removing a signal not corresponding to the user voice based on the audio signal and the speech feature information. Referring to FIG. 2, the processor 120 may obtain the mask information by inputting the audio signal and the speech feature information into the trained sound quality enhancement module 1020 and receiving the mask information as an output from the trained sound quality enhancement module 1020 (or a trained neural network model included therein).

Here, the “first voice signal” is used as a term to refer to the voice signal obtained from the audio signal before the speech feature information is updated, and may be distinguished from a “second voice signal” described below. If the speech feature information has yet to be updated, the voice signal shown in FIG. 2 or 3 may represent the first voice signal.

The “sound quality enhancement module 1020 (or a speech enhancement module)” may be a third neural network model (i.e., the sound quality enhancement model) trained to generate the mask information to retain only the user voice in the input audio signal. In an embodiment, the sound quality enhancement module 1020 may include the third neural network model and may include other components. The “mask information” refers to information used to reinforce a component corresponding to the user voice in the audio signal and may suppress remaining components corresponding to noise or another user voice, and also be referred to as a term such as “filtering information.”

For example, the mask information may include a plurality of weights between 0 and 1. Each of the plurality of weights may correspond to each of a plurality of cells in the spectrogram corresponding to the audio signal. Each of the plurality of weights may indicate that a higher value is likely to correspond to the user voice, and a lower value is likely to correspond to noise or another user voice.

If the mask information is obtained, the processor 120 may obtain the first voice signal by applying the mask information to the audio signal. In detail, if the mask information is obtained using the sound quality enhancement module 1020, the processor 120 may obtain the first voice signal by multiplying, as shown by an X-mark block in FIG. 2, each of the plurality of cells in the spectrogram corresponding to the audio signal by each of the plurality of weights of the mask information corresponding to each of the plurality of cells.

For example, among the plurality of cells in the spectrogram, a cell corresponding to a weight of 0.8 in the mask information may retain 80% of its original value, and the user voice may thus be reflected relatively strongly, and among the plurality of cells in the spectrogram, a cell corresponding to a weight of 0.2 in the mask information may retain 20% of its original value, and the user voice may thus be reflected relatively weakly.

After the mask information is applied to the audio signal, the processor 120 may perform an inverse short-time Fourier transform (inverse STFT) to transform the spectrogram into a time domain, thereby obtaining the first voice signal.

The processor 120 may obtain the noise signal that is distinguished from the first voice signal from the audio signal based on the audio signal and the first voice signal. As described above, the noise signal may collectively refer to remaining signals from the audio signal excluding the signal corresponding to the user voice, i.e., the voice signal.

As shown in FIG. 2, the processor 120 may obtain the noise signal that may be distinguished from the first voice signal from the audio signal by using the noise estimation module 1030. In detail, if the audio signal and the voice signal are input to the noise estimation module 1030 (e.g. a trained neural network), the noise estimation module 1030 may extract the noise signal from the audio signal and output the noise signal that is extracted. In addition, the noise estimation module 1030 may output the voice signal extracted together with the noise signal or the input voice signal together with the noise signal.

In an embodiment, the processor 120 may obtain the noise signal by removing a component corresponding to the first voice signal from the audio signal.

In an embodiment, the processor 120 may obtain the noise signal by estimating a signal in a first section of the audio signal that does not include the first voice signal as the noise signal in a second section that includes the first voice signal and is adjacent to the first section. For example, the audio signal may include a first section that does not include the first voice signal and a second section that is adjacent to the first section, and the processor 120 may obtain the noise signal by estimating a signal in a the first section of the audio signal that does not include the first voice signal as the noise signal for the first section, and using the signal that is estimated as the noise signal for in the a second section that includes the first voice signal and is adjacent to the first section.

In other words, if the first section is a section that does not include the first voice signal and only includes the noise signal, the noise signal in the first section is likely to continue to the second section (e.g., to affect or be present in the second section) adjacent to the first section. Accordingly, the processor 120 may estimate the noise signal in the first section as the noise signal in the second section. Furthermore, the processor 120 may obtain the noise signal included in an entire audio signal by applying this method to an entire section of the audio signal. This embodiment may enhance the accuracy of the estimation, in particular, in an environment where noise around the electronic device 100 does not change rapidly.

In an embodiment, the sound quality enhancement module 1020 (e.g., a neural network model included therein) may be trained to output the first voice signal and the noise signal included in the input audio signal. In this case, the processor 120 may obtain the first voice signal and the noise signal by inputting the audio signal and the speech feature information into the sound quality enhancement module 1020 and receiving the first voice signal and the noise signal as output from the sound quality enhancement module 1020 (or the trained neural network model included therein). In other words, the sound quality enhancement module 1020 (or the trained neural network model included therein) may be trained not only to output only noise information, but also to isolate the voice signal and the noise signal from the input audio signal and output the voice signal together with the noise signal, respectively.

The processor 120 may identify at least one clean section in the first voice signal, in which an amount of the noise signal is less than a threshold value, based on the first voice signal and the noise signal.

The “clean section” refers to a section in which the amount of the noise signal (e.g., an amount of noise) (or a ratio of the noise signal) in the first voice signal is less than the threshold value. In an embodiment, the threshold value may vary depending on a user setting or a developer setting. In the present disclosure, the “voice data” refers to a set of voice signals included in each clean section, and may be used as a term to distinguish the corresponding voice signal from the other voice signals (e.g., the first voice signal and the second voice signal).

As shown in FIG. 2, the processor 120 may identify at least one clean section by using the clean section identification module 1040. In detail, if the voice signal and the noise signal are received, the clean section identification module 1040 may compare the respective sections of the noise signal and identify the clean section where the amount of the noise signal is less than the threshold value.

If at least one clean section is identified, the processor 120 may update the speech feature information based on the voice data corresponding to at least one clean section. If at least one clean section is identified, the processor 120 may identify the voice signal corresponding to each of at least one clean section, and obtain the voice data based on the identified voice signal. If a plurality of clean sections are identified, the processor 120 may merge the voice signals corresponding to the plurality of clean sections in the order of the respective sections to obtain the voice data.

If the voice data is obtained, the processor 120 may update the speech feature information based on the voice data. In detail, as shown in FIG. 2, the processor 120 may update the speech feature information by inputting the voice data corresponding to the clean section into the speech feature extraction module 1010 (e.g., the second neural network model included therein) instead of the registered voice signal.

Meanwhile, if the plurality of clean sections are identified, the processor 120 may continuously update the speech feature information by sequentially using the voice data corresponding to each of the plurality of clean sections.

For example, at least one clean section may include a first clean section and a second clean section after the first clean section. In this case, the processor 120 may update the speech feature information based on voice data corresponding to the first clean section. In addition, the processor 120 may update the updated speech feature information and updated text feature information again based on voice data corresponding to the second clean section and text data corresponding to the second clean section.

Meanwhile, if each of the speech feature extraction module 1010 and the sound quality enhancement module 1020 includes a neural network, the processor 120 may train the neural network included in at least one of the speech feature extraction module 1010 or the sound quality enhancement module 1020 based on the updated speech feature information.

The processor 120 may obtain the second voice signal corresponding to the user voice from the audio signal based on the updated speech feature information. Here, the “second voice signal” is used as a term to refer to the voice signal obtained from the audio signal after the speech feature information is updated, and may be distinguished from the “first voice signal” described above. After the speech feature information is updated, the voice signal shown in FIG. 2 or 3 may represent the first voice signal.

The updated speech feature information may be information updated using the voice data in the clean section in which the amount of the noise signal is less than the threshold value in the voice signal, and thus more effectively represent the user speech feature compared to the speech feature information before the update. Furthermore, the sound quality of the voice signal corresponding to the user voice may be enhanced if the user voice is extracted from the audio signal based on the updated speech feature information.

Meanwhile, the processor 120 may control the operation of the electronic device 100 based on the second voice signal. In detail, the processor 120 may input the second voice signal into the voice recognition model to obtain a text corresponding to the second voice signal as an output from the voice recognition model. In addition, the processor 120 may input the obtained text into a natural language processing model to obtain information about a user intention included in the text as an output from the natural language processing model. In addition, the processor 120 may control the operation of the electronic device 100 based on the information about the user intention.

According to an embodiment described above, the electronic device 100 may enhance the sound quality of the user voice spoken in a noisy environment, thereby effectively and efficiently enhancing the accuracy of voice recognition. In addition, the enhanced accuracy of voice recognition may be applied to various technologies such as voice control, machine translation, and the like.

The electronic device 100 may effectively achieve the sound quality enhancement because the electronic device 100 may update the feature vector by using the voice data in the clean section having the least amount of noise in the user voice, unlike a related art technology that performs the sound quality enhancement by using a fixed feature vector extracted from a pre-registered voice or a voice including the predetermined keyword.

In addition, the electronic device 100 may obtain the voice data in the clean section from the input audio signal even if the input audio signal does not include information corresponding to the keyword, and use the obtained voice data for the sound quality enhancement.

Furthermore, the various embodiments according to the present disclosure may be performed by using a loop-back structure as shown in FIG. 2, and the sound quality enhancement as described above may thus be achieved in real time and gradually while the audio signal is continuously obtained.

FIG. 3 is a block diagram showing the plurality of modules according to an embodiment of the present disclosure.

Referring to FIG. 3, the plurality of modules according to the present disclosure may further include a text feature extraction module 1050 and a voice recognition module 1060. Hereinafter, an embodiment related to using the text feature extraction module 1050 is first described, and an embodiment related to using the voice recognition module 1060 is then described.

In the description provided with reference to FIGS. 1 and 2, an embodiment related to obtaining the first voice signal from the audio signal by using the speech feature module is described. However, hereinafter, an embodiment related to obtaining the first voice signal from the audio signal by using the text feature extraction module 1050 together with the speech feature module is described.

The processor 120 may obtain information about the keyword and the reference voice signal including a user voice corresponding to the keyword before the audio signal is obtained. Here, the “keyword” refers to one or more words set by the user or a developer. For example, the keyword may be set as a keyword for activating a voice recognition function of the electronic device 100, and therefore may be referred to as a term such as a “trigger word.” The keyword may be changed by the developer or the user, and a plurality of keywords may be specified.

The processor 120 may obtain the text feature information based on the information about the keyword. As shown in FIG. 3, the processor 120 may obtain the text feature information by inputting the information about the keyword into the text feature extraction module 1050. The “text feature extraction module 1050” may be a first neural network model (i.e., the text feature extraction model) trained to extract a feature corresponding to the input keyword. In an embodiment, the text feature extraction module 1050 may include the first neural network model and may include other components.

The “text feature information” may collectively refer to information representing a feature of the keyword. For example, the text feature information may include one or more feature vectors of or corresponding to the keyword. The text feature information may include a vector representing a unique feature of the keyword. The text feature information may be replaced with a term such as a “text feature value”, a “text the feature vector”, or “text feature embedding.” The text feature information may be obtained after the audio signal is obtained, or may be pre-obtained and stored in the memory 110 before the audio signal is obtained.

The “reference voice signal” refers to a signal obtained if the user speaks the keyword. The reference voice signal indicates a signal obtained if the user speaks the keyword, and the speech feature information obtained based on the reference voice signal may thus include the information about the user speech feature for the keyword. The reference voice signal may be a signal obtained if the user speaks in the noisy environment, and may thus include noise, which may indicate that there is room for enhancement in the sound quality.

The processor 120 may obtain the first voice signal from the audio signal based on the text feature information including information about a feature of the keyword and the speech feature information including the information about the user speech feature for the predetermined keyword.

The processor 120 may obtain the speech feature information by extracting a feature corresponding to the text feature information from the reference voice signal. In detail, the processor 120 may obtain the speech feature information by inputting the reference voice signal and the text feature information into the trained speech feature information extract module.

For example, if the keyword is “Hi, my secretary”, the processor 120 may obtain a text feature vector representing a feature of the keyword “Hi, my secretary.” In addition, if the user speaks “Hi, my secretary”, the processor 120 may receive the reference voice signal based on the speech of the user. The processor 120 may obtain the speech feature information based on identifying a component corresponding to the text feature vector representing the feature of the keyword “Hi, my secretary” in the reference voice signal.

As described above, by using the text information extraction module together with the speech feature extraction module 1010, the electronic device 100 may identify the component representing the feature of the keyword in the audio signal, thereby obtaining the speech feature information, and may use the voice data and the text data in the clean section instead of the reference voice signal that may include noise.

Therefore, the electronic device 100 may obtain the speech feature information that represents the user speech feature more accurately than a case of using only the speech feature extraction module 1010 (or the second trained neural network included therein). Furthermore, the sound quality of the user voice may be significantly enhanced if the user voice is extracted from the audio signal by using the updated speech feature information.

In addition, in an embodiment described with reference to FIG. 3, if the user speaks the keyword, the electronic device 100 may obtain the speech feature information by using the text feature information representing the feature of the keyword together with the reference voice signal based on the speech. Therefore, the electronic device 100 does not need the process of registering the user voice by having the user speak the keyword at least a single time and determining whether the spoken word matches the keyword, as shown in an embodiment described with reference to FIG. 2.

Meanwhile, the processor 120 may obtain a text corresponding to the voice signal by using the voice recognition module 1060, and may use the obtained text to update the speech feature information. The “voice recognition module 1060” may be a neural network model trained to output the text corresponding to the input voice signal, that is, a neural network model referred to as an “automatic speech recognition model (ASR) model.”

The processor 120 may obtain the text corresponding to the voice data by inputting the voice data into the voice recognition module 1060 and receiving the text as an output from the voice recognition module 1060. The processor 120 may obtain text data corresponding to at least one clean section based on the obtained text. The “text data” refers to a set of texts included in each clean section, and may be used as a term to be distinguished from the text corresponding to the voice signal.

In detail, the processor 120 may identify text information corresponding to each of at least one clean section in the obtained text, and obtain the text data based on the identified text information. If the plurality of clean sections are provided, the processor 120 may obtain the text data by merging the text information respectively corresponding to the plurality of clean sections in the order of the respective sections.

If the text data is obtained, the processor 120 may update the text feature information based on the text data. In detail, as shown in FIG. 3, the processor 120 may update the text feature information by inputting the text data corresponding to the clean section into the text feature extraction module 1050 instead of the keyword.

In addition, the processor 120 may update the speech feature information based on the updated text feature information and the voice data corresponding to the clean section. In detail, as shown in FIG. 3, the processor 120 may update the speech feature information by inputting the voice data corresponding to the clean section together with the updated text feature information into the speech feature extraction module 1010 instead of the reference voice signal.

Meanwhile, if the text feature extraction module 1050, the speech feature extraction module 1010, or the sound quality enhancement module 1020 includes the neural network (e.g., the first to third trained neural networks), the processor 120 may train the neural network included in at least one of the text feature extraction module 1050, the speech feature extraction module 1010, or the sound quality enhancement module 1020 based on the updated speech feature information and the updated text feature information.

If the text feature extraction module 1050, the speech feature extraction module 1010, or the sound quality enhancement module 1020 includes the neural network, two or more among text feature extraction module 1050, the speech feature extraction module 1010, and the sound quality enhancement module 1020 may be implemented as a single integrated neural network model.

As described above, if the processor 120 obtains the text data corresponding to the clean section in which the amount of the noise signal is less than the threshold value from the voice signal and updates the speech feature information by using the obtained text data, the processor 120 may more effectively represent the user speech feature compared to the speech feature information before the update, thereby further enhancing the sound quality of the voice signal corresponding to the user voice

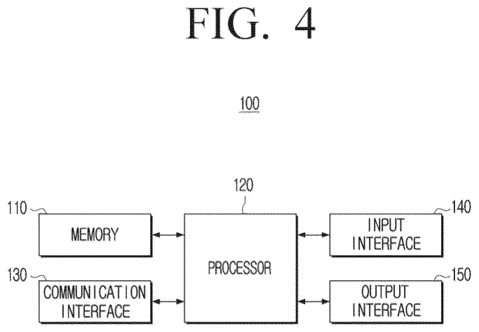

FIG. 4 is a block diagram showing a specific configuration of the electronic device 100 according to an embodiment of the present disclosure.

In an embodiment, the electronic device 100 may include the memory 110, the processor 120, a communication interface 130, an input interface 140, and an output interface 150. The communication interface 130 may include circuitry and communicate with the external device. In detail, the processor 120 may receive various data or information from the external device connected thereto through the communication interface 130, and also transmit the various data or information to the external device.

The communication interface 130 may include at least one of a wireless fidelity (Wi-Fi) module, a Bluetooth module, a wireless communication module, a near field communication (NFC) module, and an ultrawideband (UWB) module. In detail, the Wi-Fi module and the Bluetooth module may each communicate in a Wi-Fi manner or a Bluetooth manner. If the Wi-Fi module or the Bluetooth module is used, the communication interface 130 may first transmit and receive various connection information such as a service set identifier (SSID), and then connect communication based on this connection information, and then transmit and receive various information.

In addition, the wireless communication module may perform the communication based on various communication protocols such as institute of electrical and electronics engineers (IEEE), zigbee, third generation (3G), third generation partnership project (3GPP), long term evolution (LTE), and fifth Generation (5G). In addition, the NFC module may perform the communication by using an NFC method that uses a 13.56 MHz band among various radio frequency identification (RF-ID) frequency bands such as 135 kHz, 13.56 MHz, 433 MHz, 860 to 960 MHz, and 2.45 GHz. In addition, the UWB module may accurately measure time of arrival (ToA), which is time at which a pulse reaches a target, and an angle of arrival (AoA), which is the angle of arrival of a pulse at a transmission device, through the communication between UWB antennas, and may thus perform accurate distance and position recognition within an error range of several tens of centimeters (cm) indoors.

In an embodiment, the processor 120 may receive information about the plurality of modules, in particular, the information about the neural network model among the plurality of modules, the audio signals, the voice signals, the noise signals, the voice data, the text data, the speech feature information, the text feature information, or the like from the external device through the communication interface 130. The processor 120 may obtain a control signal corresponding to the user voice based on the second voice signal, and control a communication device to transmit the obtained control signal to the external device.

An input interface 140 may include circuitry, and the processor 120 may receive a user command for controlling the operation of the electronic device 100 through the input interface 140. In detail, the input interface 140 may include components such as the microphone, a camera, and a remote control signal receiving device. In addition, the input interface 140 may be implemented as a touchscreen included in the display. In particular, the microphone may receive the voice signal and convert the received voice signal into an electric signal.

In an embodiment, the processor 120 may receive the audio signal through the microphone. The processor 120 may receive a user input for performing the sound quality enhancement operation according to the present disclosure through the input interface 140. The processor 120 may receive a user input for setting the keyword, a user input for registering the user voice, a user input for setting the threshold value, or the like through the input interface 140.

The output interface 150 may include circuitry, and the processor 120 may output various functions that the electronic device 100 may perform through the output interface 150. In addition, the output interface 150 may include at least one of a display, a speaker, or an indicator.

The display may output image data under control of the processor 120. In detail, the display may output an image pre-stored in the memory 110 under the control of the processor 120. In particular, the display according to an embodiment of the present disclosure may display a user interface stored in the memory 110. The display may be implemented as a liquid crystal display (LCD), an organic light-emitting diode (OLED) display, or the like. In addition, the display may also be implemented as a flexible display, a transparent display, or the like in some cases. However, the display according to the present disclosure is not limited to a specific type.

The speaker may output audio data under the control of the processor 120. The indicator may be lit under the control of the processor 120. In detail, the indicator may be lit in various colors under the control of the processor 120. For example, the indicator may be implemented as a light-emitting diode (LED) display, a liquid crystal display (LCD), a vacuum fluorescent display (VFD), and is not limited thereto.

In an embodiment, the processor 120 may control the output interface 150 to output information indicating that the sound quality enhancement operation according to the present disclosure is performed. The processor 120 may control the output interface 150 to output information indicating that a voice control is performed based on the user voice, a machine translation result corresponding to the user voice, or the like.

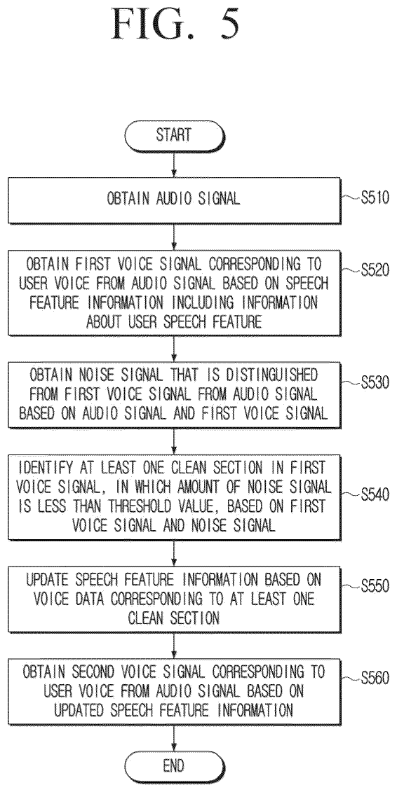

FIG. 5 is a flowchart showing a controlling method of an electronic device 100 according to an embodiment of the present disclosure.

Referring to FIG. 5, the electronic device 100 may obtain the audio signal (S510). In detail, the electronic device 100 may receive the audio signal through the microphone included in the electronic device 100, or may receive the audio signal from the external device through the communication interface 130 included in the electronic device 100.

The electronic device 100 may obtain the first voice signal corresponding to the user voice from the audio signal based on the speech feature information including the information about the user speech feature (S520). The speech feature information may be obtained after the audio signal is obtained, or may be pre-obtained and stored in the memory 110 before the audio signal is obtained.

In detail, the electronic device 100 may obtain the mask information for removing the signal not corresponding to the user voice based on the audio signal and the speech feature information. If the mask information is obtained, the electronic device 100 may obtain the first voice signal by applying the mask information to the audio signal.

The electronic device 100 may obtain the noise signal that is distinguished from the first voice signal from the audio signal based on the audio signal and the first voice signal (S530).

In an embodiment, the electronic device 100 may obtain the noise signal by removing the component corresponding to the first voice signal from the audio signal.

In an embodiment, the electronic device 100 may obtain the noise signal by estimating the signal in the first section of the audio signal that does not include the first voice signal, as the noise signal and using the noise signal as the noise signal in the second section that includes the first voice signal and is adjacent to the first section.

In an embodiment, the sound quality enhancement module 1020 may be trained to output the first voice signal and the noise signal included in the input audio signal. In this case, the electronic device 100 may input the audio signal and the speech feature information into the sound quality enhancement module 1020 to obtain the first voice signal and the noise signal as output from the sound quality enhancement module 1020.

The electronic device 100 may identify at least one clean section in the first voice signal, in which the amount of the noise signal is less than the threshold value, based on the first voice signal and the noise signal (S540). In detail, if the first voice signal and the noise signal are received, the electronic device 100 may compare the respective sections of the noise signal, and identify the at least one clean section in which the amount of the noise signal is less than the threshold value.

The electronic device 100 may update the speech feature information based on the voice data corresponding to at least one clean section (S550).

If at least one clean section is identified, the electronic device 100 may identify the voice signal corresponding to each of at least one clean section and obtain the voice data based on the identified voice signal. If the plurality of clean sections are identified, the electronic device 100 may obtain the voice data by merging the voice signals corresponding to the plurality of clean sections in the order of the respective sections. If the voice data is obtained, the electronic device 100 may update the speech feature information based on the voice data.

Meanwhile, if the plurality of clean sections are identified, the electronic device 100 may continuously update the speech feature information by sequentially using the voice data corresponding to each of the plurality of clean sections.

For example, at least one clean section may include the first clean section or the second clean section after the first clean section. In this case, the electronic device 100 may update the speech feature information based on the voice data corresponding to the first clean section. In addition, the electronic device 100 may update the updated speech feature information and the updated text feature information again based on the voice data corresponding to the second clean section and the text data corresponding to the second clean section.

The electronic device 100 may obtain the second voice signal corresponding to the user voice from the audio signal based on the updated speech feature information (S560). The updated speech feature information may be information updated using the voice data in the clean section in which the amount of the noise signal is less than the threshold value in the voice signal, and thus more effectively represent the updated speech feature information compared to the speech feature information before the update. Furthermore, the sound quality of the voice signal corresponding to the user voice may be enhanced if the user voice is extracted from the audio signal based on the updated speech feature information.

Meanwhile, the electronic device 100 may control the operation of the electronic device 100 based on the second voice signal. In detail, the electronic device 100 may input the second voice signal into the voice recognition model to obtain a text corresponding to the second voice signal. In addition, the electronic device 100 may input the obtained text into a natural language processing model to obtain information about a user intention included in the text. In addition, the electronic device 100 may control the operation of the electronic device 100 based on the information about the user intention.

Meanwhile, the controlling method of an electronic device 100 according to an embodiment described above may be implemented as a program and provided to the electronic device 100. In particular, the program including the controlling method of an electronic device 100 may be provided by being stored in a non-transitory computer-readable recording medium.

In detail, in the non-transitory computer-readable recording medium including the program for executing the controlling method of an electronic device 100, the method may include obtaining the first voice signal corresponding to the user voice from the audio signal based on the speech feature information including the information about the user speech feature if the audio signal is obtained, obtaining the noise signal that is distinguished from the first voice signal from the audio signal based on the audio signal and the first voice signal, identifying at least one clean section in the first voice signal, in which the amount of the noise signal is less than the threshold value, based on the first voice signal and the noise signal, updating the speech feature information based on the voice data corresponding to the at least one clean section, and obtaining the second voice signal corresponding to the user voice from the audio signal based on the updated speech feature information.

Hereinabove, the controlling method of an electronic device 100 and the computer-readable recording medium including the program for executing the controlling method of an electronic device 100 are briefly described, only to omit redundant descriptions thereof, and the various embodiments regarding the electronic device 100 may also be applied to the controlling method of an electronic device 100 and the computer-readable recording medium including the program for executing the controlling method of an electronic device 100.

An artificial intelligence function according to the present disclosure may be operated using the processor 120 and the memory 110 included in the electronic device 100.

The processor 120 may include one or more processors 120. Here, one or more processors 120 may include at least one of a central processing unit (CPU), a graphics processing unit (GPU), or a neural processing unit (NPU), and is not limited to the examples of the processor 120 described above.

The CPU may perform not only general calculations but also artificial intelligence calculations, and may efficiently execute complex programs through a multi-layered cache structure. The CPU may be advantageous for a serial processing method that enables organic linkage between a previous computation result and a next computation result through sequential computation. The processor 120 is not limited to the above examples unless specified as the above-mentioned CPU.

The GPU is the processor 120 for large-scale calculations such as floating-point calculations used for graphics processing, and may perform the large-scale calculations in parallel by integrating a large number of cores. In particular, the GPU may be advantageous for a parallel processing method such as convolution calculation compared to the CPU. In addition, the GPU may be used as the co-processor 120 to supplement the function of the CPU. The processor 120 for the large-scale calculations is not limited to the above example unless specified as the above-mentioned GPU.

The NPU may be the processor 120 specialized in the artificial intelligence calculation using an artificial neural network, and may implement each layer included in the artificial neural network in hardware (e.g., silicon). Here, the NPU is specially designed based on requirements of a company, and may thus have a lower degree of freedom than the CPU or the GPU. However, the NPU may efficiently process the artificial intelligence calculation required by the company. Meanwhile, as the processor 120 specialized for the artificial intelligence calculation, the NPU may be implemented in various forms such as a tensor processing unit (TPU), an intelligence processing unit (IPU), or a vision processing unit (VPU). The artificial intelligence processor 130 is not limited to the above example unless specified as the above-mentioned NPU.

In addition, the processor 120 may be implemented in a system on chip (SoC). Here, the SoC may further include the memory 120 and a network interface such as a bus for data communication between the processor 120 and the memory 110 in addition to the processor 120.

If the system on chip (SoC) included in the electronic device 100 includes the plurality of processors 120, the electronic device 100 may use some of the plurality of processors 120 to perform the artificial intelligence calculation (e.g., calculation related to the learning or inference of the artificial intelligence model). For example, the electronic device 100 may perform the artificial intelligence calculation by using at least one of the GPU, the NPU, the VPU, the TPU, or a hardware accelerator that is specialized for the artificial intelligence calculation such as convolution calculation and matrix multiplication calculation among the plurality of processors 120. However, this configuration is only an example, and the display device may process the artificial intelligence calculation by using the general-purpose processor 120 such as the CPU.

In addition, the electronic device 100 may perform calculation for the artificial intelligence function by using multiple cores (e.g., dual-core or quad-core) included in one processor 120. In particular, the electronic device 100 may perform the artificial intelligence calculation such as the convolution calculation and the matrix multiplication calculation in parallel using the multiple cores included in the processor 120.

At least one processor 120 may perform the control to process the input data based on a predefined operation regulation or the artificial intelligence model, stored in the memory 120. The predefined operation regulation or the artificial intelligence model may be obtained by the learning.

Here, “obtained by the learning” may indicate that the predefined operation regulation or artificial intelligence model of a desired feature is obtained by applying a learning algorithm to a lot of learning data. Such learning may be performed by a device itself in which the artificial intelligence is performed according to the disclosure, or may be performed by a separate server/system.

The artificial intelligence model may include a plurality of neural network layers. At least one layer has at least one weight value, and a calculation of the layer may be performed based on a calculation result of a previous layer and at least one defined calculation. Examples of the neural network may include a convolutional neural network (CNN), a deep neural network (DNN), a recurrent neural network (RNN), a restricted Boltzmann machine (RBM), a deep belief network (DBN), a bidirectional recurrent deep neural network (BRDNN), a deep Q-network, and a transformer. However, the neural network of the disclosure is not limited to the above examples unless otherwise specified.

The learning algorithm is a method for training a predetermined target device (e.g., robot) by using a large number of learning data for the predetermined target device to make a decision or a prediction for itself. Examples of the learning algorithms may include a supervised learning algorithm, an unsupervised learning algorithm, a semi-supervised learning algorithm, or a reinforcement learning algorithm. However, the learning algorithm of the disclosure is not limited to the above-described examples unless otherwise specified.

A machine-readable storage medium may be provided in the form of a non-transitory storage medium. Here, the “non-transitory storage medium” may refer to a tangible device and only indicate that this storage medium does not include a signal (e.g., electromagnetic wave), and this term does not distinguish a case where data is stored semi-permanently in the storage medium and a case where data is temporarily stored in the storage medium from each other. For example, the “non-transitory storage medium” may include a buffer in which data is temporarily stored.

According to an embodiment, the methods according to the various embodiments disclosed in the disclosure may be included and provided in a computer program product. The computer program product may be traded as a commodity between a seller and a purchaser. The computer program product may be distributed in a form of the machine-readable storage medium (e.g., a compact disc read only memory (CD-ROM)), or may be distributed online (e.g., by download or upload) via an application store (e.g., PlayStore™) or directly between two user devices (e.g., smartphones). In case of the online distribution, at least a part of the computer program product (e.g., downloadable app) may be at least temporarily stored or temporarily provided in the machine-readable storage medium such as the memory 110 of a manufacturer server, an application store server, or a relay server.

Each of components (for example, modules or programs) according to the various embodiments of the present disclosure as described above may include a single entity or a plurality of entities, and some of the corresponding sub-components described above may be omitted or other sub-components may be further included in the various embodiments. Alternatively or additionally, some of the components (for example, the modules or the programs) may be integrated into one entity, and may perform functions performed by the respective corresponding components before being integrated in the same or similar manner.

Operations performed by the modules, the programs or other components according to the various embodiments may be executed in a sequential manner, a parallel manner, an iterative manner or a heuristic manner, at least some of the operations may be performed in a different order or be omitted, or other operations may be added.

Meanwhile, the term “˜er/˜or” or “module” used in the disclosure may include a unit including hardware, software or firmware, and may be used interchangeably with the term, for example, a logic, a logic block, a component or a circuit. The “˜er/˜or” or “module” may be an integrally formed component, or a minimum unit or part performing one or more functions. For example, the module may include an application-specific integrated circuit (ASIC).

The various embodiments of the disclosure may be implemented by software including an instruction stored in the machine-readable storage medium (for example, a computer-readable storage medium). A machine may be an apparatus that invokes the stored instruction from the storage medium, may be operated based on the invoked instruction, and may include the electronic device (e.g., the electronic device 100) according to the disclosed embodiments.

If the instruction is executed by the processor, the processor may directly perform a function corresponding to the instruction or other components may perform the function corresponding to the instruction under a control of the processor. The instruction may include a code provided or executed by a compiler or an interpreter.

Although the embodiments of the present disclosure are shown and described as above, the present disclosure is not limited to the above-mentioned specific embodiments, and may be variously modified by those skilled in the art to which the present disclosure pertains without departing from the gist of the present disclosure as claimed in the accompanying claims. These modifications should also be understood to fall within the scope and spirit of the present disclosure.

What is claimed is:

1. An electronic device comprising:
memory storing at least one instruction; and
a processor configured to execute the at least one instruction,
wherein the processor is configured to:
obtain a first voice signal corresponding to a user voice from an audio signal based on speech feature information including information about a user speech feature,
obtain a noise signal from the audio signal based on the audio signal and the first voice signal, the noise signal being distinguished from the first voice signal,
identify at least one clean section in the first voice signal, based on the first voice signal and the noise signal, the at least one clean section having an amount of the noise signal that is less than a threshold value,
update the speech feature information based on voice data corresponding to the at least one clean section, and
obtain a second voice signal corresponding to the user voice from the audio signal based on the updated speech feature information.

2. The electronic device as claimed in claim 1, wherein:
the speech feature information includes information about the user speech feature for a keyword, and
the processor is configured to obtain the first voice signal from the audio signal based on text feature information including information about a feature of the keyword and the speech feature information.

3. The electronic device as claimed in claim 2, wherein the processor is configured to:
obtain a text corresponding to the voice data by inputting the voice data into a voice recognition module and receiving the text as an output from the voice recognition module,
obtain text data corresponding to the at least one clean section based on the text,
update the text feature information based on the text data, and
update the speech feature information based on the updated text feature information and based on the voice data.

4. The electronic device as claimed in claim 2, wherein the processor is configured to:
before the audio signal is obtained, obtain information about the keyword and a reference voice signal including a user voice corresponding to the keyword,
obtain the text feature information based on the information about the keyword,
extract a feature corresponding to the text feature information from the reference voice signal, the speech feature information including the feature that is extracted, and
store the text feature information and the speech feature information in the memory.

5. The electronic device as claimed in claim 4, wherein the processor is configured to:
obtain the text feature information by inputting the information about the keyword into a text feature extraction module including a first trained neural network and receiving the text feature information as an output from the first trained neural network, and
obtain the speech feature information by inputting the reference voice signal and the text feature information into a speech feature extraction module including a second trained neural network and receiving the speech feature information as an output from the second trained neural network.

6. The electronic device as claimed in claim 5, wherein the processor is configured to:
obtain mask information based on the audio signal and the speech feature information, the mask information for removing a signal that does not correspond to the user voice, and
apply the mask information to the audio signal to remove the signal that does not correspond to the user voice in order to obtain the first voice signal corresponding to the user voice.

7. The electronic device as claimed in claim 6, wherein the processor is configured to obtain the mask information by inputting the audio signal and the speech feature information into a sound quality enhancement module including a third trained neural network and receiving the mask information as an output from the third trained neural network.

8. The electronic device as claimed in claim 7, wherein the third trained neural network included in the sound quality enhancement module is trained to output the first voice signal and the noise signal that are included in the audio signal that has been input to the sound quality enhancement module, and
the processor is configured to obtain the first voice signal and the noise signal by inputting the audio signal and the speech feature information into the sound quality enhancement module and receiving the first voice signal and the noise signal as outputs from the sound quality enhancement module.

9. The electronic device as claimed in claim 8, wherein the processor is configured to train at least one of the first neural network, the second neural network, or the third neural network based on the updated speech feature information and the updated text feature information.

10. The electronic device as claimed in claim 1, wherein the processor is configured to obtain the noise signal by removing a component corresponding to the first voice signal from the audio signal.

11. The electronic device as claimed in claim 1, wherein:
the audio signal includes a first section that does not include the first voice signal and a second section that is adjacent to the first section, and
the processor is configured to obtain the noise signal by estimating a signal in the first section of the audio signal as the noise signal for the first section, and to use the signal that is estimated as the noise signal for the second section.

12. The electronic device as claimed in claim 1, wherein the at least one clean section includes a first clean section and a second clean section after the first clean section, and
the processor is configured to:
update the speech feature information based on the voice data corresponding to the first clean section and text data corresponding to the first clean section to generate updated speech feature information, and
update the updated speech feature information based on the voice data corresponding to the second clean section and text data corresponding to the second clean section.

13. The electronic device as claimed in claim 1, wherein the audio signal does not include a signal corresponding to a keyword.

14. A method of an electronic device, the method comprising:
obtaining a first voice signal corresponding to a user voice from an audio signal based on speech feature information including information about a user speech feature;
obtaining a noise signal from the audio signal based on the audio signal and the first voice signal, the noise signal being distinguished from the first voice signal;
identifying at least one clean section in the first voice signal, based on the first voice signal and the noise signal, the at least one clean section having an amount of the noise signal that is less than a threshold value;
updating the speech feature information based on voice data corresponding to the at least one clean section; and
obtaining a second voice signal corresponding to the user voice from the audio signal based on the updated speech feature information.

15. The method as claimed in claim 14, wherein:
the speech feature information includes information about the user speech feature for a keyword, and
the first voice signal is obtained from the audio signal based on text feature information including information about a feature of the keyword and the speech feature information.

16. An electronic device comprising:
memory that stores program code, and at least one processor that executes the program code to cause the at least one processor to:
obtain a first voice signal corresponding to a user voice from an audio signal based on user speech feature vectors,
identify at least one clean section in the first voice signal, the at least one clean section having an amount of noise that is less than a threshold value,
update the user speech feature vectors based on voice data corresponding to the at least one clean section, and
obtain a second voice signal corresponding to the user voice from the audio signal based on the updated user speech feature vectors.

17. The electronic device as claimed in claim 16, wherein:
the user speech feature vectors include a feature vector corresponding to a keyword, and
the first voice signal is obtained from the audio signal based on the feature vector corresponding to the keyword.

18. The electronic device as claimed in claim 16, wherein the at least one processor is configured to:
input the voice data into a voice recognition module and receive text corresponding to the voice data as an output from the voice recognition module,
obtain text data corresponding to the at least one clean section from the text, and
update the user speech feature vectors based on the text data.

19. The electronic device as claimed in claim 16, wherein the at least one clean section is identified based on a noise signal obtained from the audio signal.

20. The electronic device as claimed in claim 16, wherein:
the audio signal includes a first section that includes noise but does not include the first voice signal and a second section that is adjacent to the first section, and
the at least one processor is configured to obtain the noise signal by estimating a noise signal in the first section of the audio signal, and by using the noise signal that is estimated for the second section.
